(19) United States
(12) Patent Application Publication
(10) Pub. No.: US 2016/0004484 A1
(43) Pub. Date: Jan. 7, 2016

(54) PRINT CONTROL METHOD AND RECORDING MEDIUM STORING PRINT CONTROL PROGRAM

(71) Applicants: Teruyoshi YAMAMOTO, Tokyo (JP); Naoyuki URATA, Kanagawa (JP); Kanna IINUMA, Kanagawa (JP); Kenichi FUJIOKA, Kanagawa (JP); Masahiro FUKUDA, Tokyo (JP); Yukihiro HAYAKAWA, Kanagawa (JP); Yuu YAMASHITA, Kanagawa (JP); Akira TERUYA, Kanagawa (JP); Ken MITSUI, Kanagawa (JP); Mitsutaka TAKEDA, Tokyo (JP); Yusuke KAWATSU, Tokyo (JP); Megumi OKUMURA, Tokyo (JP)

(72) Inventors: Teruyoshi YAMAMOTO, Tokyo (JP); Naoyuki URATA, Kanagawa (JP); Kanna IINUMA, Kanagawa (JP); Kenichi FUJIOKA, Kanagawa (JP); Masahiro FUKUDA, Tokyo (JP); Yukihiro HAYAKAWA, Kanagawa (JP); Yuu YAMASHITA, Kanagawa (JP); Akira TERUYA, Kanagawa (JP); Ken MITSUI, Kanagawa (JP); Mitsutaka TAKEDA, Tokyo (JP); Yusuke KAWATSU, Tokyo (JP); Megumi OKUMURA, Tokyo (JP)

(73) Assignee: Ricoh Company, Ltd., Tokyo (JP)

(21) Appl. No.: 14/755,227

(22) Filed: Jun. 30, 2015

(30) Foreign Application Priority Data
Jul. 1, 2014 (JP) 2014-136150
May 12, 2015 (JP) 2015-097519

(51) Int. Cl. G06F 3/12

(52) U.S. Cl. CPC G06F 3/1204; G06F 3/1258; G06F 3/1263; G06F 3/1276; G06F 3/1297

(57) ABSTRACT

Disclosed is a non-transitory computer-readable recording medium storing a print control program, which when executed by a processor, causes an information processing apparatus connected to a printer via a network to perform a process. The process includes causing a screen generator to generate a plurality of screens via which respective instructions for a plurality of print settings are received from a user, causing a display controller to display setting items corresponding to the screens in a predetermined order, and control switching between the screens based on the respective instructions corresponding to the setting items received from the user, and causing a print setting limiter to limit the respective print settings, for which the respective instructions are received from the user via the respective screens, based on the predetermined order of the setting items.

### BACKGROUND OF THE INVENTION

1. Field of the Invention

The disclosures herein generally relate an information processing apparatus, a print control method for use in the information processing apparatus, and a non-transitory computer-readable recording medium storing a print control program.

2. Description of the Related Art

There is provided an externally provided DFE (digital front end) controller for performing high-speed image processing. The DFE controller is connected via a network to client PCs (personal computers) serving as information processing apparatuses, each of which is provided with a printer driver function to handle print settings.

In the production printing industry, output printed matter often directly serves as a product (commercial product). Accordingly, in the printer driver for use in the production printing, it is necessary to initially set a desired product to be created, and subsequently specify settings for the desired product such as an imposition, a type of paper, a type of finishing, and the like. Further, the cost of the production printing not only includes the cost of producing the printed matter, but also includes a time for performing settings for the product. Hence, it is necessary not only for experienced operators but also for inexperienced operators to create the desired print product (output) as quickly as they can without hesitation.

Thus, there have been proposed technologies for constructing printer drivers employing user interfaces capable of creating the print product (output) by reducing steps of operations without allowing those inexperienced operators to hesitate to perform the operations.

Japanese Laid-open Patent Publication No. 2005-25304 (hereinafter referred to as “Patent Document 1”), for example, discloses “an electronic application system, an electronic application method, and a program” for facilitating online creation or online submission of documents as a technology well-known in the art.

In the printer drivers having user interfaces to which the electronic application system according to Patent Document 1 is applied, the operator needs to select a desired one of comparative types of driver functions for production printing. Hence, operators who are inexperienced with the drivers may be confused, and may select items that are not related to the desired output result, despite the fact that the operators have already determined the desired output. This may lead to erroneous operations. Thus, in the related art technologies, categories of the user interfaces may confuse the users of the production printing, which may result in elongation of operations time due to erroneous settings.

Specifically, the following case is assumed. For example, regarding the first driver function, output-conscious settings reside in an imposition tab but the initial display is set as quick access. Hence, the user (operator) may fail to recognize that he or she needs to switch to the layout tab and/or, the user may fail to recognize how he or she is able to switch to the layout tab. Further, when print settings are performed in accordance with a flow of the printing process, settings are performed by switching to an imposition tab, a sheet tab, a finishing tab, and the sheet tab, in this order, and the user may fail to know how he or she is able to perform settings. In addition, since all the values for the finishing may be settable regardless of the print settings of the layout and the sheet, the value for the finishing may be wrongly specified, leading to erroneous operations. In addition, the settings change in the above case may result in the change of the setting value in the finishing. As a result, the settings or the like associated with N-Up (i.e., printing data of plural pages in one page) may be changed, which may confuse the user in identifying the desired output.

Similarly, regarding the second driver function, the settings for the output reside in a central layout tab but the initial display is a color tab. Hence, the user (operator) who is desired to select output types may fail to recognize that he or she needs to switch the color tab to the layout tab.

### RELATED ART DOCUMENT

### Patent Document

Patent Document 1: Japanese Laid-open Patent Publication No. 2005-25304

### SUMMARY OF THE INVENTION

Accordingly, it is a general object in one embodiment of the present invention to provide a print control method for use in an information processing apparatus, and a non-transitory computer-readable recording medium storing a print control program capable of facilitating user interface functions to allow a user of production printing to intuitively handle the user interface functions by only displaying to the user settable values so as to reduce erroneous setting operations, which substantially obviate one or more problems caused by the limitations and disadvantages of the related art.

According to an aspect of embodiments, there is disclosed a non-transitory computer-readable recording medium storing a print control program, which when executed by a processor, causes an information processing apparatus connected to a printer via a network to perform a process. The process includes causing a screen generator to generate a plurality of screens via which respective instructions for a plurality of print settings are received from a user; causing a display controller to display setting items corresponding to the screens in a predetermined order, and control switching between the screens based on the respective instructions corresponding to the setting items received from the user; and causing a print setting limiter to limit the respective print settings, for which the respective instructions are received from the user via the respective screens, based on the predetermined order of the setting items.

According to another aspect of embodiments, there is provided a print control method for use in an information processing apparatus connected to a printer via a network. The print control method includes causing a screen generator to generate a plurality of screens via which respective instructions for a plurality of print settings are received from a user, the screen generator being constructed within the information processing apparatus; causing a display controller to display setting items corresponding to the screens in a predetermined order, and control switching between the screens based on the respective instructions corresponding to the setting items received from the user, the display controller being constructed within the information processing apparatus; and causing a print setting limiter to limit the respective print settings, for which the respective instructions are received from the user via the respective screens, based on the predetermined order of the setting items, the print setting limiter being constructed within the information processing apparatus.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating an example of a basic configuration of a print system including information processing apparatuses to which a print control program according to a first embodiment is applied, and a printer configured to perform color printing;

FIG. 2 is a block diagram illustrating a basic hardware configuration of the information processing apparatus disposed in the print system illustrated in FIG. 1;

FIG. 3 is a block diagram illustrating a basic hardware configuration of the printer disposed in the print system illustrated in FIG. 1;

FIG. 4 is a block diagram illustrating a functional configuration of a printer driver formed in the information processing apparatus disposed in the print system illustrated in FIG. 1;

FIG. 5 is a flowchart illustrating an example of a print process by production printing associated with a user interface in the printer driver illustrated in FIG. 4;

FIG. 6 is a diagram illustrating an example of a display screen of a display part considering the print process by the production printing associated with the user interface in the printer driver illustrated in FIG. 5;

FIG. 7 is a diagram illustrating another example of the display screen of the display part considering the print process by the production printing associated with the user interface in the printer driver illustrated in FIG. 5;

FIG. 8 is a schematic diagram illustrating as a process flow a basic concept of exclusive control performed by a print screen controller associated with a user interface in the printer driver illustrated in FIG. 4;

FIG. 9 is a diagram illustrating an example of the display screen of the display part in a gray-out process performed by the print screen controller associated with the user interface in the printer driver illustrated in FIG. 4;

FIG. 10 is a diagram illustrating another example of the display screen of the display part in the gray-out process performed by the print screen controller associated with the user interface in the printer driver illustrated in FIG. 4;

FIG. 11 is a diagram illustrating another example of the display screen of the display part in the gray-out process performed by the print screen controller associated with the user interface in the printer driver illustrated in FIG. 4;

FIG. 12 is a diagram illustrating an example of an exclusive control list of an exclusive information storage part associated with the user interface in the printer driver illustrated in FIG. 4;

FIG. 13 is a schematic diagram illustrating an example of the exclusive control performed by the print screen controller using the exclusive control list illustrated in FIG. 12 as a process flow;

FIGS. 14A and 14B are diagrams illustrating control coordinates and menu coordinates indicating positional information of screens stored in a print setting value storage part provided for generating limitation information used in limitation of print settings performed by the print screen controller formed in the information processions apparatus of a print system according to a second embodiment; and

FIG. 15 is a schematic diagram illustrating a generation example of the exclusive control list performed by the print screen controller with reference to positional information of screens stored in the print setting value storage part and an exclusive specification of the exclusive information storage part associated with the user interface in the printer driver illustrated in FIGS. 14A and 14B as a process flow.

### DETAILED DESCRIPTION OF THE PREFERRED EMBODIMENTS

In the following, a detailed description is given of embodiments of a print control method, and a print control program stored in a non-transitory computer-readable recording medium with reference to the accompanying drawings.

### First Embodiment

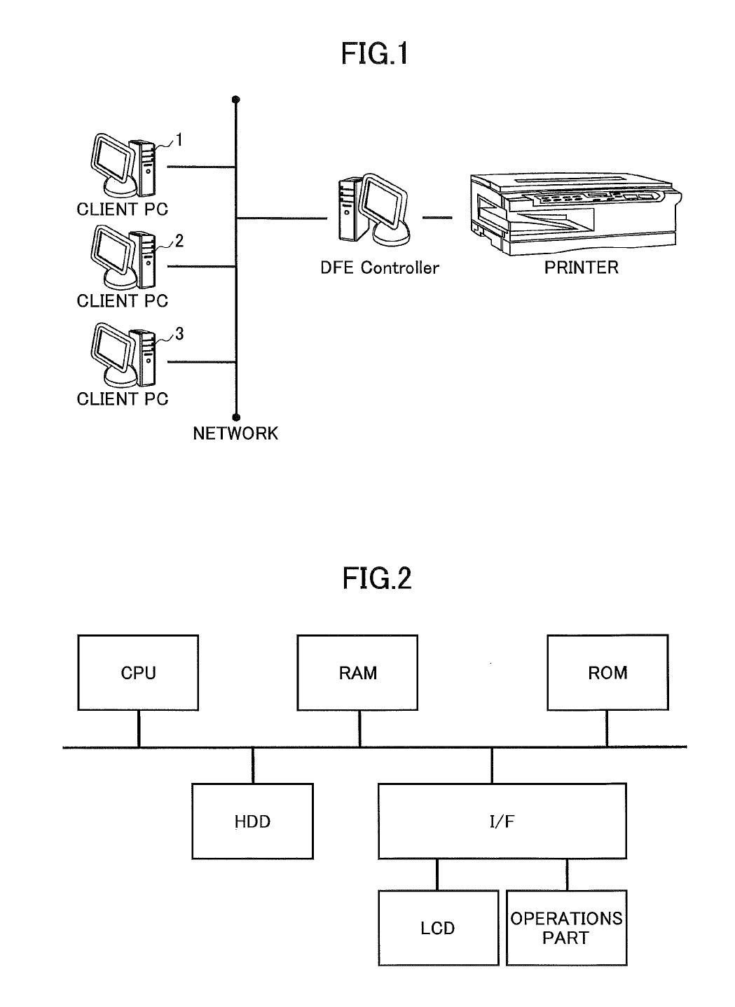

FIG. 1 is a schematic diagram illustrating an example of a basic configuration of a print system including information processing apparatuses to which a print control program according to a first embodiment is applied, and a printer configured to perform color printing. The print system is configured to include three client PCs (personal computers) 1 to 3 serving as information processing apparatuses connected via a network to a DFE controller for performing high-speed image processing externally connected to a color printer. In each of the client PCs 1 to 3, a printer driver function to set color printing by utilizing a user interface is constructed by executing the later-described print control program.

In the print system, as basic operations, when users operate the client PCs 1 to 3 to utilize user interfaces to set color printing, and transfer JDF job tickets to the DFE controller via a network to transmit print instructions, the DFE controller translates the received JDF job tickets to transmit the print instructions to the printer. Note that the number of the connected client PCs is not limited to three.

FIG. 2 is a block diagram illustrating a basic hardware configuration of the information processing apparatuses (client PCs 1 to 3). Each of the client PCs 1 to 3 includes a CPU (central processing unit) having a processor function and serving as a controller to control operating processes of components of the PC, a RAM (random access memory) formed of a high-speed information readable-writable volatile storage medium and serving as a work area of the CPU for performing information processing, a ROM (read-only memory) serving as a read-only nonvolatile ROM storing programs such as firmware, an HDD (hard disk drive) formed of a nonvolatile information readable-writable storage medium storing an OS (operating system), various types of control programs, application programs, and the like, and a network interface (I/F) that are connected via a bus. Note that the above-described print control programs are stored in the HDD.

Of these, the network interface (I/F) is connected to LCD (liquid crystal display) serving as a display part, and an operations part, and is used for connecting the bus and the hardware components, or the network to control the connection. Note that the respective LCDs are used by users to visually check the statuses of the client PCs 1 to 3. The operations parts are such as a keyboard, a mouse, and the like used by the users who input information into the client PCs 1 to 3. These components function as user interfaces, respectively.

Note that in FIG. 2, an illustration is given of the functional configurations of the client PCs 1 to 3 designed for the personal computers; however, hardware configurations of servers and other mobile terminals are formed in a similar manner to those of the personal computers. Hence, the servers and other mobile terminals may be substituted for the client PCs 1 to 3.

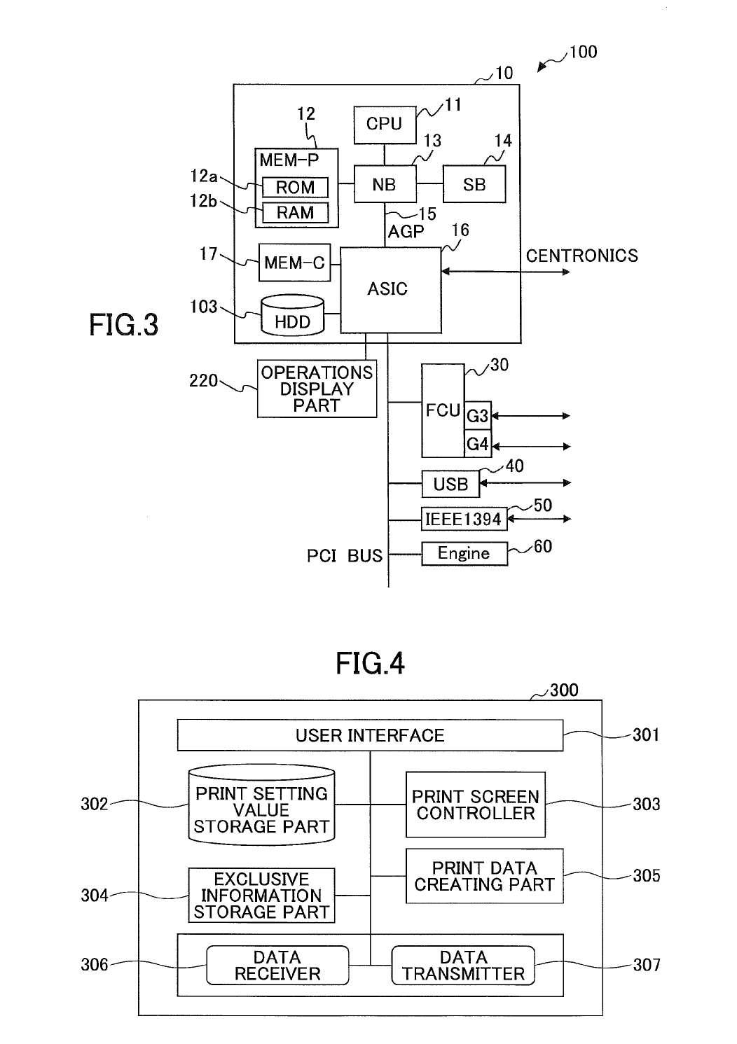

FIG. 3 is a block diagram illustrating a basic hardware configuration of a printer 100. The printer 100 is a multifunctional apparatus designed as a MFP (peripheral functional peripheral), which includes two or more functions such as a printer function, a copier function, a scanner function, and a facsimile function disposed in one housing. The printer 100 is configured to have a controller 10 and be connected to an engine 60 with a PCI (peripheral component interface) bus.

The controller 10 includes a function to control overall operations, drawing, communications, and inputs from a not-illustrated operations part. The engine 60 serves as an engine of the printer connectable to the PCI bus, and may be configured to include a monochrome plotter, a one drum color plotter, a four drum color plotter, a scanner, or a facsimile unit. Note that the engine 60 further includes an image processor to perform error diffusion or gamma conversion, in addition to so-called engine parts such as a plotter, and the like.

The controller 10 performs overall control of the printer 100, and is configured to include a CPU 11 connected to other apparatuses via a chip set composed of a north bridge NB 13, a system memory MEM-P 12 having a ROM (read only memory) 12a and a RAM (random access memory) 12b, and a south bridge SB 14; a local memory MEM-C 17 utilized as a copying image buffer or code buffer; a hard disk drive HDD 103 that serves as a storage configured to accumulate image data, programs, font data, forms, and store a license list of applications executed in the printer 100; and an ASIC (application specific integrated circuit) 16 that is an IC (integrated circuit) having image processing hardware components, designed for the image processing, and serves as a bridge connected between the north bridge NB 13 and each of an AGP (accelerated graphical port) bus 15, a PCI bus, the hard disk drive HDD 103, and the local memory MEM-C 17.

Of these, the north bridge NB 13 serves as a bridge connected to the CPU 11, the system memory MEM-P 12, the south bridge SB 14, and the AGP bus 15, and includes a memory controller function to control reading or writing with respect to the system memory MEM-P 12, a PCI master function, and an AGP target function.

The system memory MEM-P 12 may be used as a storage memory to store programs or data, a loading memory in which the programs or data are loaded, a plotting memory of the printer, and the like, and configured to include the ROM 12a and the RAM 12b. The ROM 12a is a read only memory used as a storage to store programs or data, the RAM 12b is readable and writable memory used as a loading memory, in which the programs or data are loaded, or used as the printer plotting memory.

The south bridge SB 14 serves as a bridge between the north bridge NB 13 and a PCI bus or other peripheral devices, and is connected to the north bridge NB 13 via the PCI bus. Note that the PCI bus is connected to a network interface (I/F) and the like.

The ASIC 16 has a parallel port connectable two-way communications Centronics interface compatible, and includes a PCI target function, an AGP master function, an arbiter serving as a central player, a memory controller configured to control the local memory MEM-C 17, two or more DMACs (direct memory access controllers) configured to rotate image data by hardware logic or the like, and a PCI unit configured to perform data transfer between the engine 60 and the ASIC 16 via the PCI bus. Further, the ASIC 16 is connected to an FCU (facsimile control unit) 30 having signal transmitter-receivers G3 and G4, a USB (universal serial bus) 40, and an IEEE 1394 (Institute of Electrical and Electronics Engineers 1394) interface 50. Moreover, the ASIC 16 is directly connected to an operations display part 220.

The AGP bus 15 is a bus interface for graphics accelerator cards for accelerating graphical processing, and accelerates the graphical accelerator card by directly accessing the system memory MEM-P 12 with high throughput.

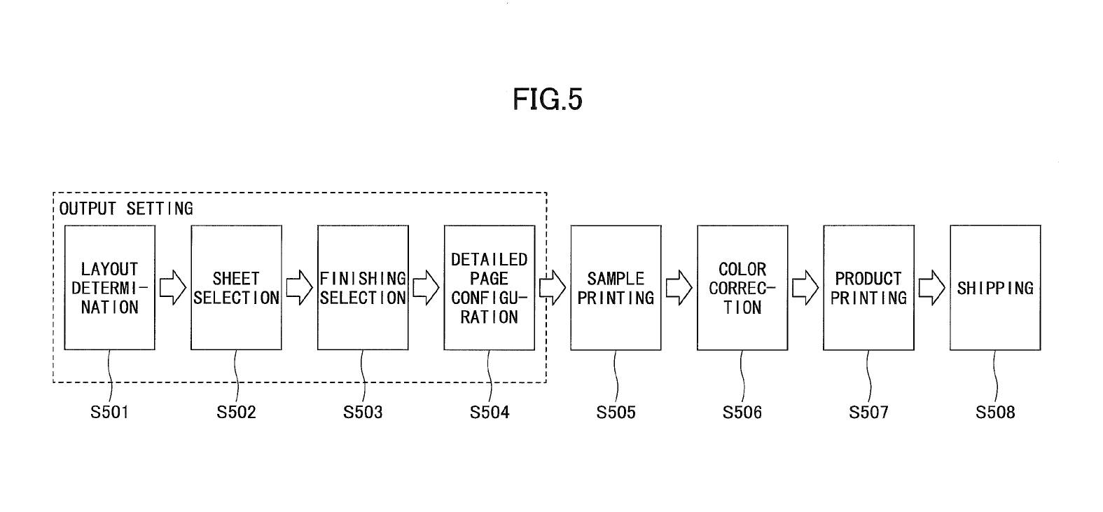

FIG. 4 is a block diagram illustrating a functional configuration of a printer driver 300 formed in the information processing apparatuses (client PCs 1 to 3). The printer driver 300 is configured to perform settings of color printing utilizing a user interface 301. The printer driver 300 includes a not-illustrated CPU configured to control operation processes of components via the user interface 301 belonging to the network interface (I/F) illustrated in FIG. 2 in accordance with the print control program read from the above-described HDD; a print setting value storage part 302 configured to store, upon receiving the operations control of the CPU, print setting values set as a basic level associated with the color printing displayed on the display part (LCD) via a basic setting screen by the operations part and detailed print setting values set as a detailed level via a detailed setting screen by the operations part; an exclusive information storage part 304 configured to store an exclusive control list as exclusive information about various types of functions; a print screen controller 303 configured to perform, upon receiving the operations control of the not-illustrated CPU, exclusive control to generate a print setting screen based on various types of setting values acquired from the print setting value storage part 302 and the exclusive control list of the exclusive information storage part 304; a print data creating part 305 configured to create, upon receiving the operations control of the not illustrated CPU, print data for color printing based on the print setting value and the detailed print setting value; a data transmitter 307 configured to transmit, upon receiving the operations control of the not illustrated CPU, the print data to the printer 100 through the DFE controller via the network; and a data receiver 306 configured to receive, upon receiving the operations control of the not illustrated CPU, information from the printer 100 through the DFE controller via the network.

In this printer driver 300, the user is able to perform color setting on the operations part via the user interface 301 while the user monitors the display screen of the display part (LCD). The print setting value and detailed print setting value set by specifying operations on the basic setting screen, and the detailed setting screens in two phases are saved in the print setting value storage part 302. At this time, the print screen controller 303 refers to the exclusive control list of the exclusive information storage part 304, and optionally performs exclusive control at the time of generating the print setting screen. The exclusive control may, for example, be displaying higher-order functions in preference to lower-order functions on the setting screen when there is an exclusive relationship between the higher-order functions and the lower-order functions in contents of the exclusive control list. Further, when a print start instruction is received via the user interface 301, the print data creating part 305 creates print data for color printing based on the print setting value and the detailed print setting value saved in the print setting value storage part 302, and transmits the created print data via the data transmitter 304 to the printer 100. Further, to acquire information from the printer 100, the information is received via the data receiver 306 from the printer 100, and the received data are displayed on the display part (LCD) via the user interface 301.

Meanwhile, the not-illustrated functional CPU in the printer driver 300 executes the print control program, using the print setting value storage part 302, and the exclusive information storage part 304, to cause the print screen controller 303 associated with the above-described user interface 301 to perform a print setting process in collaboration with one another. The process includes a screen generator configured to generate two or more screens capable of receiving two or more instructions for the print settings from the user; a display controller configured to display setting items corresponding to each of the screens in a predetermined order, and switching between the screens in response to the user's instructions for the setting items; and a print setting limiter configured to restrict the print settings capable of receiving the instructions from the user via each of the screens in the order that the setting items will function.

Of these, the setting items handled by the display controller include an imposition setting, a sheet setting, a finishing setting, a detailed page setting, and a color adjustment setting; and the predetermined order is to include a layout setting, the sheet setting, the finishing setting, the detailed page setting, and the color adjustment setting. The print setting limiter may limit the lower-order print settings, when there is an exclusive relationship between the higher-order print settings for which instructions are received based on the screens corresponding to the setting items displayed at the higher-order setting positions in the predetermined order, and the lower-order print settings for which instructions are received based on the screens corresponding to the setting items displayed at the lower-order setting positions in the predetermined order.

Further, the print screen generator displays the categories of the user interface 301 in the print process order by receiving the operation specification of the operations part and initially displaying an output selection screen associated with the print output that allows the user to set any value with respect to the display part (LCD). In collaboration with the print screen generator, the print setting limiter limits the functions in the order of the layout setting (the highest priority), the sheet setting, the finishing setting, the detailed page setting, and the color adjustment setting, and the predetermined order includes the layout setting, the sheet setting, the finishing setting, the detailed page setting, and the color adjustment setting (lowest priority) in accordance with the display of the categories. As a result, the display part (LCD) displays the categories of the user interface in the print process order by initially displaying the output selection screens associated with the print output. The user is allowed to set any value on the output selection screen of the display part (LCD) by the operation specification of the operations part.

Further, the print screen generator may present on the display part (LCD) a screen with which the user may be able to check conditions at any timing under which the functions of the lower-order categories are limited. In addition, the print setting limiter may have functions of a same category of the user interface 301 by placing higher priorities on higher-order print settings for which respective instructions are received based on the screens corresponding to the setting items displayed at higher-order positions in the predetermined order, and placing lower priorities on lower-order print settings for which respective instructions are received based on the screens corresponding to the setting items displayed at lower-order positions in the predetermined order. As a result, the exclusive control for displaying the setting screen is performed such that the functions placed in the higher-order positions may be displayed in preference to the functions placed in the lower-order positions when there are exclusive relationships between the functions placed in the higher-order positions and the functions placed in the lower-order positions.

FIG. 5 is a flowchart illustrating an example of a print process by production printing associated with the user interface 301 in the above-described printer driver 300.

With reference to FIG. 5, the user initially performs the output setting by considering a desired output such as creating a booklet, a magazine, or a ring stitching book in the print process according to the production printing in the printer driver 300. The output setting roughly include four steps. The first step includes an imposition determination (step S501) in which content determining the layout is specified. Examples of the content determining the layout include 1-up or 2-up, the page order of the booklet, speed printing or double printing, finally cut, margin for each page, and the like. The second step includes a sheet selection step (step S502), in which the sheet suitable for the output (print output) determined based on the layout is specified. For example, when the booklet is output with an A4-size, the sheet is specified by considering the specification of an A3-size or above. The third step includes a finishing selection step (step S503) in which an appropriate post process to be executed is specified. For example, the user desires to specify saddle stitching for the booklet, or the user specifies the saddle stitching while setting a staple. Or when the user desires to create a ring stitching book, the user specifies a ring so as to enable ring stitching. The fourth step includes a detailed page configuration (step S504) in which the user desires to change the content specified in the first to third steps for each of the pages when the user desires to change any. For example, when the user desires to create a product having a sheet of a cover page being replaced with another sheet, a product having a color sheet for each chapter, and a product having every plural pages stapled, the user sets the desired product in this step.

After the output setting, a sample printing step (step S505), and a color correction step (step S506) are performed, and the execution of actual printing, and arrangement and color of the layout are subsequently checked. Specifically, it may be difficult to check the color while setting, and hence, the sample printing (step S505) and color correction (step S506) may be repeated a few or several times. After the execution of these steps without any problems, a product printing step (step S507) is subsequently performed to print a final output (print output), and the final output is shipped as a commercial product in a final shipping step (step S508).

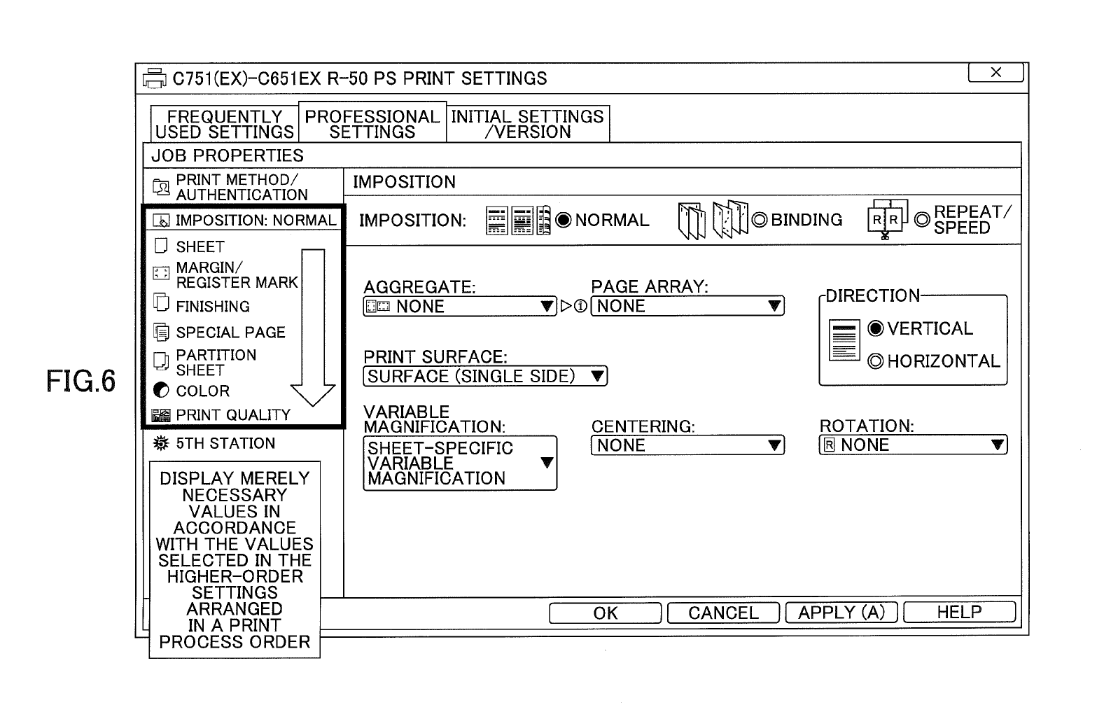

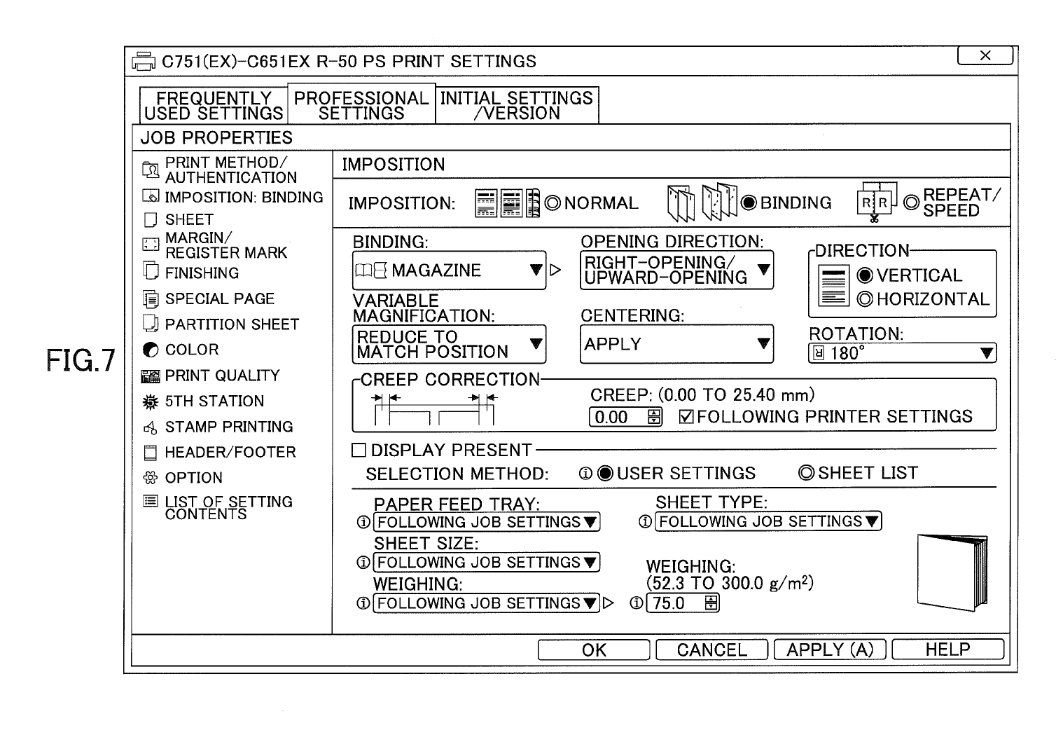

FIG. 6 is a diagram illustrating an example of a display screen of the display part (LCD) considering the print process by the production printing associated with the user interface 301 in the above-described printer driver 300. Similarly, FIG. 7 is a diagram illustrating an example of the display screen of the display part (LCD) considering the print process by the production printing associated with the user interface 301 in the above-described printer driver 300.

With reference to FIGS. 6 and 7, the display screen of the display part (LCD) associated with the print process initially displays an imposition tab, and deliberately presents the output such as normal, binding, and repeat/speed to the user. Accordingly, the user will not be confused when the user needs to determine the desired output in production printing. Further, the display screen of the display part (LCD) merely displays necessary settings or necessary values in accordance with the desired output.

For example, the normal specification illustrated in FIG. 6 includes an N-Up specification, and a double-side specification, and the like. However, the binding specification illustrated in FIG. 7 may need to perform a 2-Up specification and the double-side specification, and hence, they are not included in the setting screen. Instead, only the functions necessary for binding, such as magazine imposition or mini-booklet imposition, or an opening direction, are displayed by the control of the print screen controller 303. Hence, it may be possible to avoid wrongly setting the value that is not settable without confusing the operations with respect to the desired output. Further, in the production printing, it may be necessary to reduce a print setting time in order to reduce labor-hours as much as possible. As described above, the print settings are performed in the order of the print process such as the sheet, margin/register mark, and finishing in the imposition tab, which follows a natural operation flow from top to bottom of the menu. Hence, the production printing utilizes a UI configuration (i.e., LCD display screen associated with the user interface 301) that includes no additional setting time due to inefficient operations from the bottom to the top of the menu and the like.

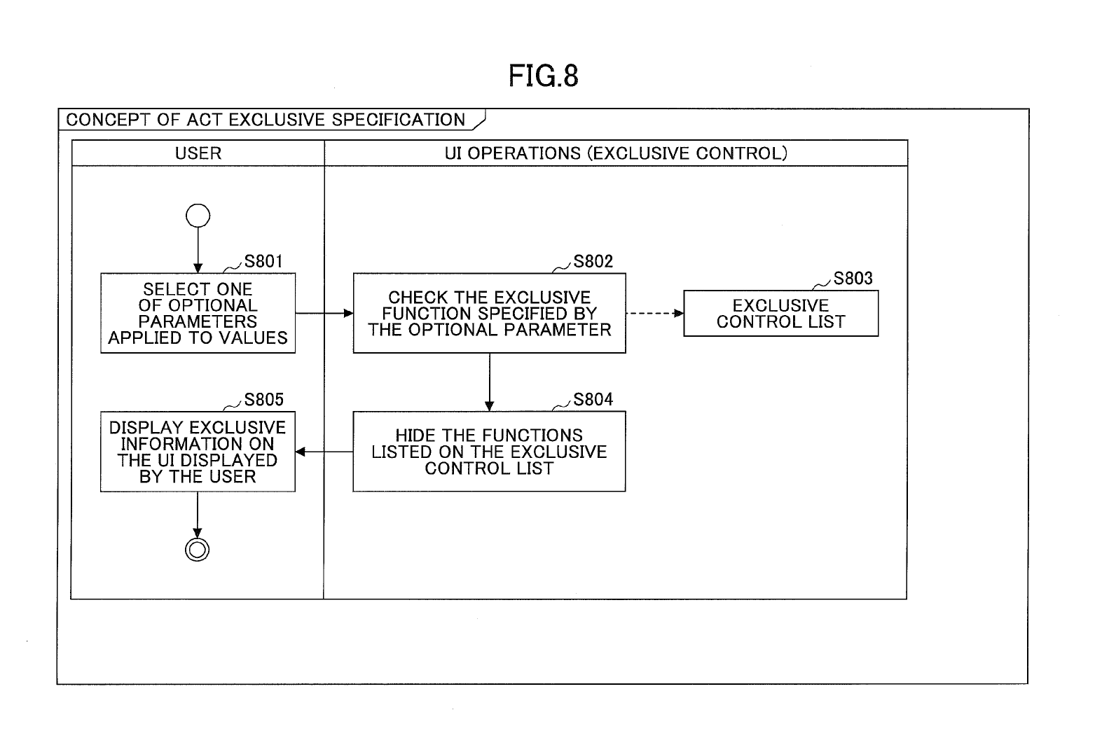

FIG. 8 is a schematic diagram illustrating as a process flow a basic concept of exclusive control performed by the print screen controller 303 associated with the user interface 301 in the above-described printer driver 300.

With reference to FIG. 8, when the user initially selects one of optional parameters applied to values (step S801), the print screen controller 303 controlling the UI operations (exclusive control) of the user interface 301 of the printer drive 300 checks the function excluded by the optional parameter selected by the user on an exclusive control list that is exclusive information of the exclusive information storage part 304 (step S802). The exclusive control list (step S803) includes levels of strength between the functions. The strong functions may be changed regardless of the weak functions; however, the weak functions are restricted by the settings of the strong functions. In this example, the higher-hierarchical functions (e.g., layout) listed on the first part of the print process are strong, the lower-hierarchical functions listed are weak as illustrated in FIG. 6. Of the same-hierarchical functions, the functions located in the upper positions within the same hierarchy are strong, and the functions located in the lower positions within the same hierarchy are weak. Accordingly, only settable parameters or values may be displayed by limiting the lower hierarchical functions based on the higher-hierarchal functions selected in the higher-hierarchy of the print process, e.g., by limiting the sheet-hierarchical functions based on the layout-hierarchical functions, or limiting the finishing-hierarchical functions based on the sheet-hierarchical functions. Further, the print screen controller 303 of the printer driver 300 performs a process to hide or gray-out display the functions listed on the exclusive control list (step S804). Then, the exclusive information is displayed on the UI displayed by the user (step S805).

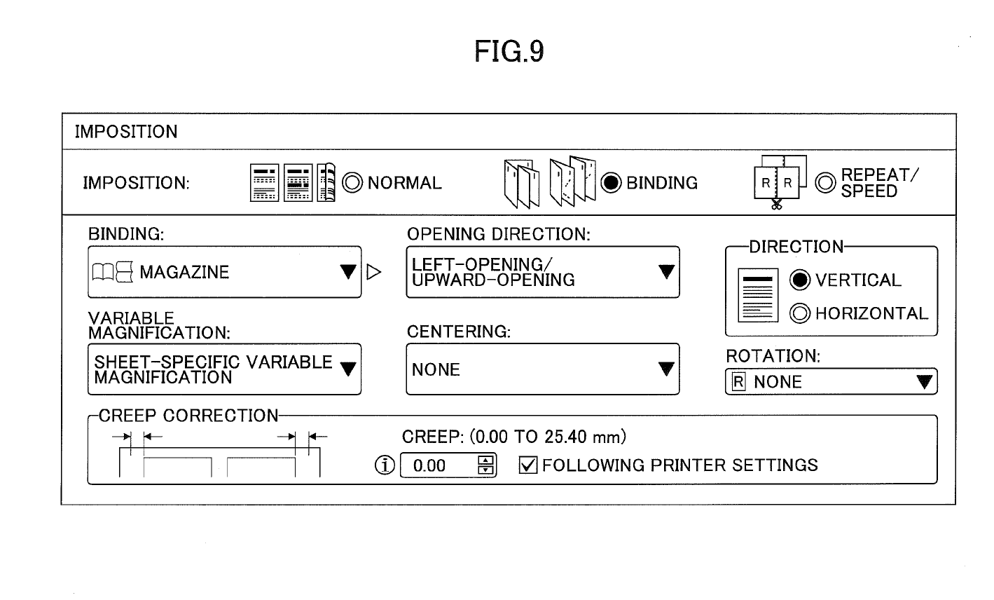

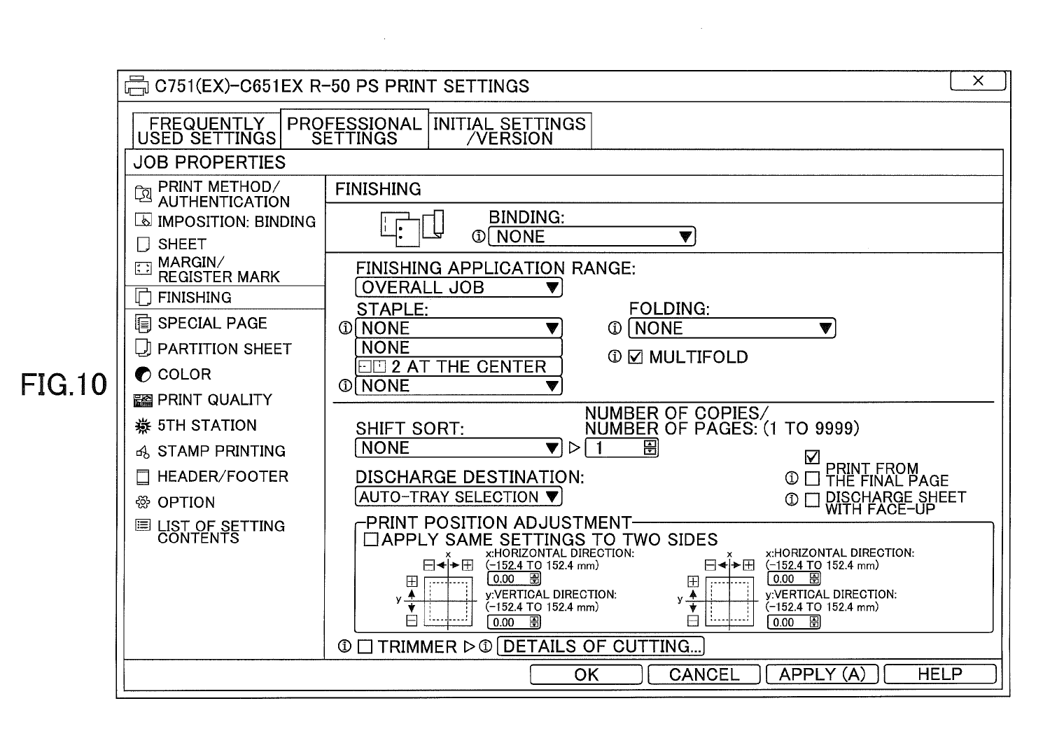

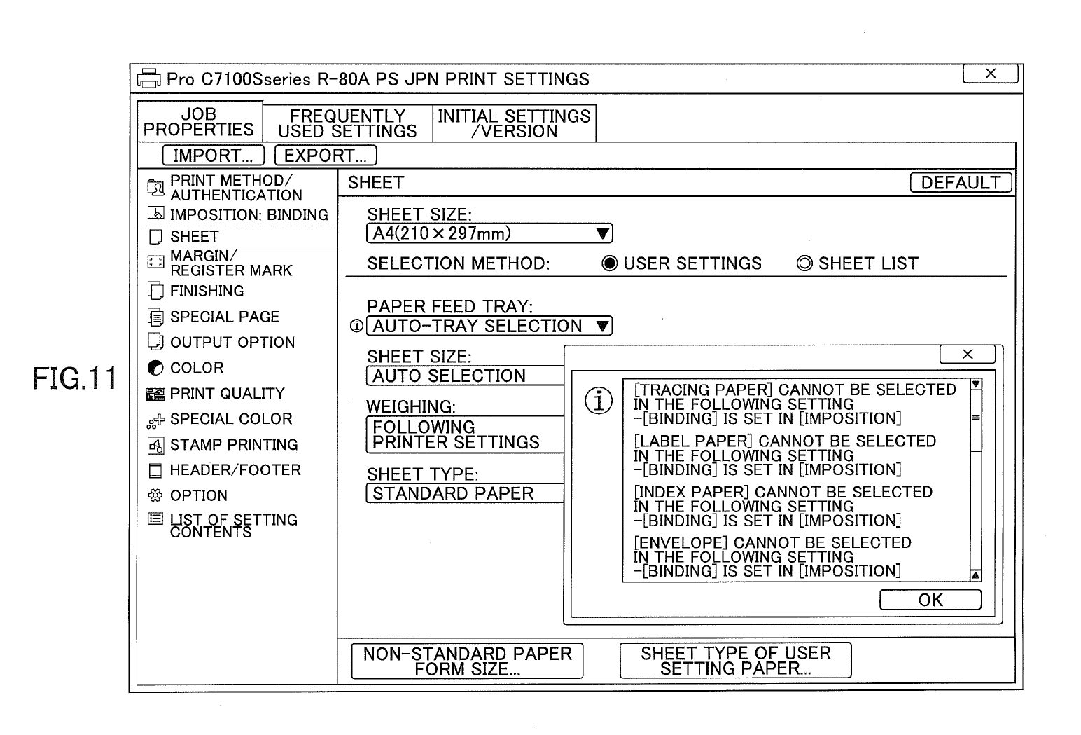

FIG. 9 is a diagram illustrating an example of the display screen of the display part (LCD) at the time of a gray-out process performed by the print screen controller 303 associated with the user interface 301 in the above-described printer driver 300. Similarly, FIG. 10 is a diagram illustrating another example of the display screen of the display part (LCD) at the time of the gray-out process performed by the print screen controller 303 associated with the user interface 301 in the above-described printer driver 300. Further, FIG. 11 is a diagram illustrating still another example of the display screen of the display part (LCD) at the time of the gray-out process performed by print screen controller 303 associated with the user interface 301 in the above-described printer driver 300.

FIGS. 9 to 11 illustrate the exclusive control illustrated in FIG. 8 performed in the display screen of the display part (LCD) associated with the gray-out process. For example, FIG. 9 illustrates an example where the user specifies the binding in the imposition, and sets a magazine in the binding as the optional parameters. In this case, the print screen controller 303 checks the exclusive control list of the exclusive information storage part 304. However, the exclusive control list describes that no optional items other than no saddle stitching may be specified in the staple when the magazine is specified. Hence, the print screen controller 303 checks the exclusive control list, and deletes optional items other than the no saddle stitching in the staple from information subjected to display on the display part (LCD) in accordance with the contents of the exclusive control list. In contrast, FIG. 10 illustrates an example where no binding (None) is specified in the finishing, and thus only no saddle stitching (Staple: None) is displayed in the staple when the user sets the staple. Further, FIG. 11 illustrates an example where the binding is set in the imposition setting, and sheet types such as tracing paper or label paper that are not settable in the binding are not displayed.

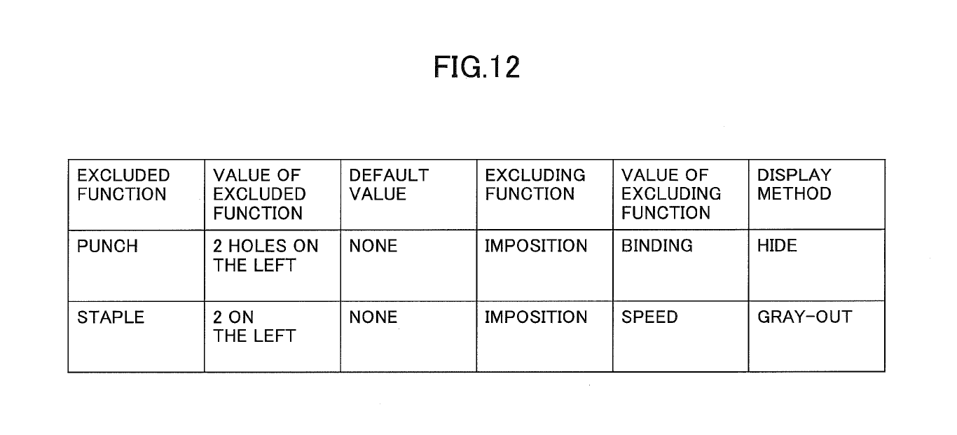

FIG. 12 is a diagram illustrating an example of the exclusive control list of the exclusive information storage part 304 associated with the user interface 301 in the printer driver 300.

With reference to FIG. 12, the excluded 1E functions are affected by the exclusive control, and have values that disable the settings as a result of the application of the exclusive control. Further, the excluding functions indicate the functions that affect the excluded functions. When the excluding functions have values of the excluding functions, and the excluded functions have values of the excluded functions, the excluded functions have default values.

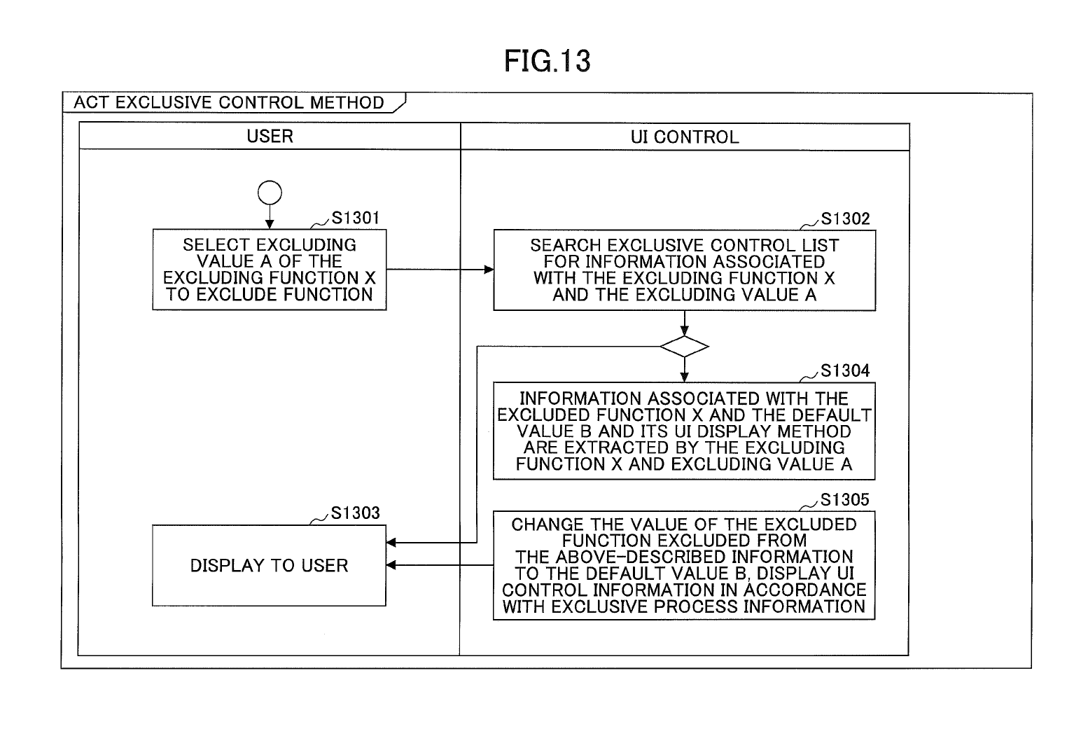

FIG. 13 is a schematic diagram illustrating an example of the exclusive control (UI control) performed 2E by the print screen controller 303 utilizing the exclusive control list as a process flow.

With reference to FIG. 13, when the user selects a value A of a function X (step S1301), the print screen controller 303 UI controlling UI operations (exclusive control) of the user interface 301 of the printer driver 300 searches for the value A and the associated function X from the exclusive control list of the exclusive information of the exclusive information storage part 304 (step S1302). As a result of the search conducted, when there is no excluding function X nor the excluding value A on the exclusive control list, the exclusive control (UI control) is not performed, and such a result is displayed to the user (step S1303). However, when there are the excluding function X and the excluding value A on the exclusive control list, information associated with the excluded function X and the default value B and its UI display method are extracted by the excluding function X and excluding value A (step S1304). Then, the value of the excluded function X is changed to the default value B, and the information about the UI control is displayed in accordance with the UI exclusive process information (step S1305), which is finally displayed to the user (step S1303).

Next, a specific example of the exclusive control is described with reference to the exclusive control list illustrated in FIG. 12. In this example, of the excluded function “punch”, the value of the excluded function “2 holes”, the excluding function “imposition”, and the value of the excluding function “binding”, when the excluded function “punch” and the value of the excluded function “2 holes” are already set in the print settings, and the excluding function “imposition” and the value of the excluding function “binding” are newly set, the value of the excluded function “punch” is replaced with the default value “None”, and the display method of the UI control for the excluded function “punch” becomes “hide” (non-display). This indicates that the excluding function “imposition” has higher priority (stronger) compared to the excluded function “punch”.

Further, of the excluded function “staple”, the value of the excluded function “2 on the left”, the excluding function “imposition”, and the value of the excluding function “speed”, when the excluded function “staple” and the value of the excluded function “2 on the left” are already set in the print settings, and the excluding function “imposition” and the value of the excluding function “speed” are newly set, the value of the excluded function “staple” is replaced with the default value “None”, and the display method of the UI control for the excluded function “staple” becomes “gray-out”. This indicates that the excluding function “imposition” has higher priority (stronger) compared to the excluded function “staple”.

Hence, the functions residing in the higher-order positions, and the UI control functions in the higher-order positions in the same screen have higher priority (stronger). Hence, the exclusive control may only be performed in a direction from the functions at the higher-order positions to the functions at the lower-order positions.

In the basic function (print control program) of the printer driver 300 according to a first embodiment, an output is selected in the output selection screen as the initial display of the display part (LCD). Hence, the inexperienced operator with the driver may be able to select a desired output without confusion. Further, the categories of the user interface 301 are displayed in the print process order so that the operator may easily and intuitively find the setting positions. Moreover, the print screen controller 303 displays on the display part only settable values in the lower-order process by performing exclusive control from the imposition of the print process to the lower-order functions in accordance with the display of the categories. Hence, risk of performing erroneous settings or erroneously selecting values may be reduced. As the above-described result, it may be possible to allow the user of production printing to intuitively and easily understand the functions of the user interface 301 by only displaying the settable values, thereby reducing additional operating time caused by erroneously settings.

The basic function (the print control program) of the printer driver 300 according to the first embodiment may serve as a print control method of performing print control for use in an information processing apparatus connected to a printer via a network. The print control method for use in the information processing apparatus includes causing a screen generator to generate a plurality of screens via which instructions for a plurality of print settings are received from a user, the screen generator being constructed within the information processing apparatus; causing a display controller to display setting items corresponding to the screens in a predetermined order, and control switching between the screens based on the respective instructions corresponding to the setting items received from the user, the display controller being constructed within the information processing apparatus; and causing a print setting limiter to limit the respective print settings capable of receiving from the user the instructions via the respective screens based on the predetermined order of the setting items, the print setting limiter being constructed within the information processing apparatus.

Note that the setting items handled by the display controller in the displaying step include layout setting, sheet setting, finishing setting, detailed page setting, and color adjustment setting; and the predetermined order of the display controller includes the layout setting, the sheet setting, the finishing setting, the detailed page setting, and the color adjustment setting. When there is an exclusive relationship between higher-order print settings for which instructions are received based on the screens corresponding to the setting items displayed at higher-order positions in the predetermined order, and lower-order print settings for which instructions are received based on the screens corresponding to the setting items displayed at lower-order positions in the predetermined order, the print setting limiter limits the lower-order print settings.

In addition, the print control method for use in the information processing apparatus further includes connecting the information processing apparatus via the network to a DFE controller externally attached to the printer and configured to perform image processing at high rates; and constructing a printer driver function configured to perform the plurality of the print settings by utilizing the user interface 301 connected to the display part (LCD) and an operations part. In the print control method, the screen generator in the generating step initially displays an output selection screen associated with a print output to which the user is able to optionally set a value by specifying operations via the operations part, and displays on the display part (LCD) categories of the user interface 301 in a print process order. In addition, the screen generator provides the display part (LCD) with a screen for a user to check, at a desired time, a condition under which functions of a lower-order category of the user interface 301 are limited.

In addition, the print setting limiter in the limiting step limits functions of a same category of the user interface 301 by placing higher priorities on higher-order print settings for which respective instructions are received based on the screens corresponding to the setting items displayed at higher-order positions in the predetermined order, and placing lower priorities on lower-order print settings for which respective instructions are received based on the screens corresponding to the setting items displayed at lower-order positions in the predetermined order.

The above-described steps of the print control method for use in the information processing apparatus are provided for constructing the print control program for use in the printer driver 300 by causing the computers (client PCs 1 to 3) to execute the print control program. Further, such a print control program may be stored in a non-transitory computer-readable recording medium capable of being read by the computers (client PCs 1 to 3).

### Second Embodiment

The basic function (a print control program) of the printer driver 300 according to a second embodiment includes, in addition to the process functions associated with the various parts illustrated with reference to FIG. 4 in the first embodiment, a function capable of allowing the user performing the print settings to change the display order of the exclusive control list stored in the exclusive information storage part 304, and a function capable of generating, when the display order is changed, the exclusive control list based on the exclusive specification stored in the exclusive information storage part 304. Note that the exclusive specification is not used for determining levels (strength) of priority between the functions, but simply indicates which functions in the printer have an exclusive relationship.

To provide such functions with the printer driver 300, when the print control program is executed to cause the print setting value storage part 302, the exclusive information storage part 304, and print screen controller 303 associated with the user interface 301 to perform a print setting process in collaboration, a positional information storage part is caused to store positional information indicating one of the screens via which the instructions for the plurality of the print settings are received; and a limit information generator is caused to generate limit information for limiting the plurality of the print settings based on the positional information and the predetermined order of the setting items. Thereafter, the print setting limiter limits the print settings for which the instructions are received from the user based on the limit information generated by the limit information generator.

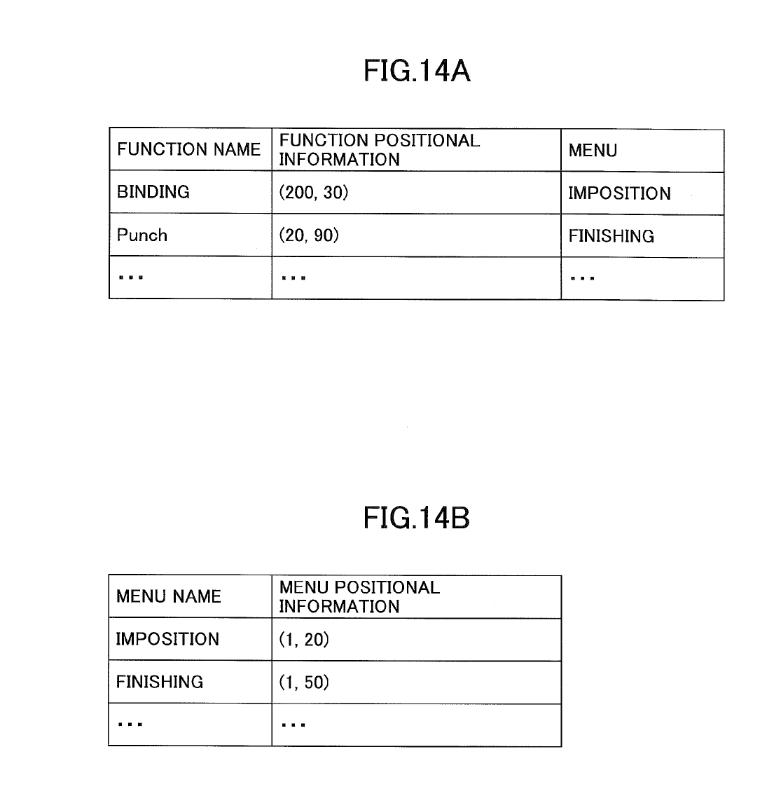

FIGS. 14A and 14B are diagrams illustrating control coordinates and menu coordinates indicating positional information of screens stored in a print setting value storage part, provided for generating limitation information used in limitation of print settings performed by the print screen controller 303 associated with the user interface 301 in the printer driver 300 formed in the information processions apparatus (client PCs 1 to 3) of a print system according to a second embodiment.

As illustrated in FIGS. 14A and 14B, the control coordinates of each function include function positional information and menu information in association with a function name. The function names such as binding, punch, and the like are defined as functions associated with respective controls, the function positional information (200,30) for the binding of the function name, and function positional information (20,90) for the punch of the function name indicate respective locations of the respective functions. In this example, the locations of the respective functions are defined based on the upper left being determined as (0,0). The function having the binding as the functional name for the imposition resides in the position (200,30) of the imposition menu, and the function having the punch as the functional name for the finishing resides in the position (20,90) of the finishing menu.

The menu coordinates of each function are associated with the menu name to define the menu positional information. The menu names “imposition”, “finishing”, and the like define functions associated with respective controls. The menu positional information (1,20) for the menu name “imposition”, and the menu positional information (1,50) for the menu name “finishing” indicate locations of the respective functions, on the basis of the upper left position being (0,0). The positional information for the control coordinates and the menu coordinates is stored in the print setting storage part 302 associated with the interface 301 of the printer driver 300, and serves as functions of the limit information generator configured to generate limit information for limiting each of the print settings based on a predetermined order of the setting items read by the print screen controller 303. As a result, exclusive control is performed so as to limit each of the print settings for which the instructions are received from the user based on the limit information associated with the print setting limiter of the print screen controller 303.

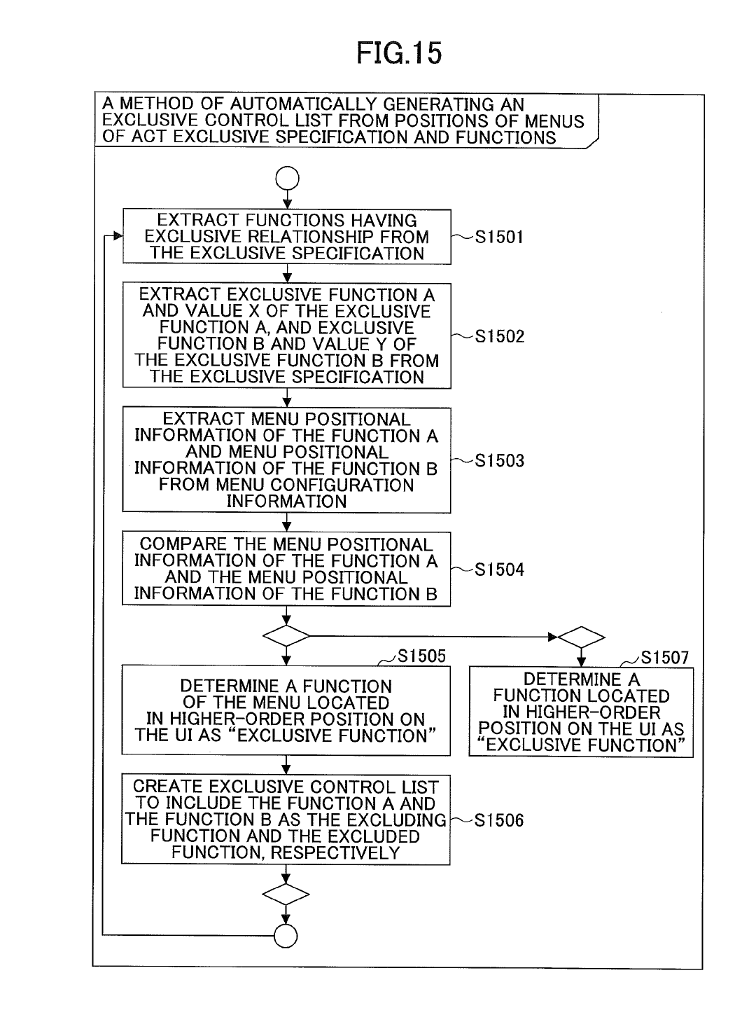

FIG. 15 is a schematic diagram illustrating an example of the exclusive control list generated by the print screen controller 303. The exclusive control list is generated with reference to positional information of screens stored in the print setting value storage part 302 and an exclusive specification of the exclusive information storage part 304 associated with the user interface 301 in the printer driver 300 as a process flow.

As illustrated in FIG. 15, it is assumed that the display order of the exclusive control list of the exclusive information storage part 304 is changed by the user performing the print settings via the print setting screen. Hence, the print screen controller 303 initially extracts the functions having the exclusive relationship from the exclusive specification stored in advance in the exclusive information storage part 304 (step S1501). In this case, there is an exclusive relationship between the binding function (exclusive function A) and the punch function (exclusive function B), and hence, these functions A and B (i.e., the binding function and the punch function) are extracted. As a result, the exclusive function A and the value X of the exclusive function A, and the exclusive function B and the value Y of the exclusive function B are extracted from the exclusive specification (step S1502).

Subsequently, the print screen controller 303 extracts the menu positional information of the exclusive function A and the menu positional information of the exclusive function B from the menu configuration information of the print setting value storage part 302 (step S1503). Then, the print screen controller 303 compares the menu positional information of the exclusive function A and the menu positional information of the exclusive function B (step S1504). The menu for the binding is the imposition, and the menu for the punch is the finishing. Thus, the binding and the punch are associated with the different menus. Accordingly, the function of the menu residing in the higher-order position in the UI (the binding in this case) is defined as the excluding function, the other function (the punch) is defined as the excluded function (step S1505). As a result, the exclusive function A and the exclusive function B are created as the excluding function and the excluded function, respectively, to form the exclusive control list (step S1506), and the above-described process is repeated until no combinations of the exclusive functions remain in the exclusive specification. Note that as a result of the comparison (step S1504) between the menu positional information of the exclusive function A and the menu positional information of the exclusive function B, when the menu positional information of the exclusive function A is equal to the menu positional information of the exclusive function B, the menu function at the higher-order position (the binding in this case) is defined as the excluding function (step S1507), and the other menu function (the punch in this case) is defined as the excluded function to form the exclusive control list to include the exclusive function A and the exclusive function B as the excluding function and the excluded function, respectively, (step S1506). Further, in this example, an illustration is given of the binding function residing in the higher-order hierarchy (higher-order position) in preference to the punch function. However, when the menu for the binding is “finishing” and the menu for the punch is “imposition” in the example illustrated in FIGS. 14A and 14B, the exclusive relationship between the above-described two functions A and B is switched, so that the excluding function results in the punch and the excluded function results in the binding.

The basic function (the print control program) of the printer driver 300 according to the second embodiment may also serve as a print control method of performing print control for use in an information processing apparatus connected to a printer via a network. The print control method for use in the information processing apparatus in this case includes a positional information storing step of causing a positional information storage part constructed within the information processing apparatus to store positional information indicating one of the screens via which instructions for the print settings are received; and a limit information generating step of causing a limit information generator constructed within the information processing apparatus to generate limit information for limiting each of the print settings based on the positional information and a predetermined order of setting items. In the print setting limiting step, the limit information generator limits each of the print settings for which instructions are received from the user based on the limit information in the limit information generating step. The above-described steps are provided for constructing the print control program for use in the printer driver 300 by causing the computers (client PCs 1 to 3) to execute the print control program. Further, such a print control program may be stored in a non-transitory computer-readable recording medium capable of being read by the computers (client PCs 1 to 3).

According to the above-described embodiments, since only the settable values are displayed, it may be possible to allow the user of production printing to intuitively and easily understand the functions of the user interface, thereby reducing additional operating time caused by erroneously settings.

The printer driver 300 according to the above-described first and second embodiments are applied to the three information processing apparatuses (client PCs 1 to 3) in the print system illustrated in FIG. 1. However, the invention is not limited to the first and second embodiments described above, and the number of information processing apparatuses may be other than three.

The present invention is not limited to the specifically disclosed embodiments, and variations and modifications may be made without departing from the scope of the present invention.

The present application is based on and claims the benefit of priority of Japanese Priority Application No. 2014-136150 filed on Jul. 1, 2014, and Japanese Priority Application No. 2015-097519 filed on May 12, 2015, the entire contents of which are hereby incorporated herein by reference.

What is claimed is:

1. A non-transitory computer-readable recording medium storing a print control program, which when executed by a processor, causes an information processing apparatus connected to a printer via a network to perform a process, the process comprising:
causing a screen generator to generate a plurality of screens via which respective instructions for a plurality of print settings are received from a user;
causing a display controller to display setting items corresponding to the screens in a predetermined order, and control switching between the screens based on the respective instructions corresponding to the setting items received from the user; and
causing a print setting limiter to limit the respective print settings, for which the respective instructions are received from the user via the respective screens, based on the predetermined order of the setting items.

2. The non-transitory computer-readable recording medium as claimed in claim 1, wherein
the setting items handled by the display controller include a layout setting, a sheet setting, a finishing setting, a detailed page setting, and a color adjustment setting, and wherein
the predetermined order indicates an order of the layout setting, the sheet setting, the finishing setting, the detailed page setting, and the color adjustment setting.

3. The non-transitory computer-readable recording medium as claimed in claim 1, wherein
when there is an exclusive relationship between a higher-order print setting for which an instruction is received based on the screen corresponding to the setting item displayed at a higher-order position in the predetermined order and a lower-order print setting for which an instruction is received based on the screen corresponding to the setting item displayed at a lower-order position in the predetermined order, the print setting limiter limits the lower-order print setting.

4. The non-transitory computer-readable recording medium as claimed in claim 1, the process further comprising:
causing a positional information storage part to store positional information indicating one of the screens via which the instructions for the plurality of the print settings are received; and
causing a limit information generator to generate limit information for limiting the plurality of the print settings based on the positional information and the predetermined order of the setting items, wherein
the print setting limiter limits the plurality of the print settings for which the instructions are received from the user based on the limit information generated by the limit information generator.

5. The non-transitory computer-readable recording medium as claimed in claim 1, wherein
the information processing apparatus is connected via the network to a controller externally attached to the printer and configured to perform image processing at high rates, wherein
the print control program is executed to construct a printer driver function to perform the plurality of the print settings by utilizing a user interface connected to a display part and an operations part, and wherein
the screen generator initially displays an output selection screen associated with a print output to which the user is able to optionally set a value by specifying operations via the operations part, and displays on the display part categories of the user interface in a print process order.

6. The non-transitory computer-readable recording medium as claimed in claim 5, wherein
the screen generator provides the display part with a screen for a user to check, at a desired time, a condition under which functions of a lower-order category of the user interface are limited.

7. The non-transitory computer-readable recording medium as claimed in claim 5, wherein
the print setting limiter limits functions of a same category of the user interface by placing higher priorities on higher-order print settings for which respective instructions are received based on the screens corresponding to the setting items displayed at higher-order positions in the predetermined order, and placing lower priorities on lower-order print settings for which respective instructions are received based on the screens corresponding to the setting items displayed at lower-order positions in the predetermined order.

8. A print control method for use in an information processing apparatus connected to a printer via a network, the print control method comprising:
causing a screen generator to generate a plurality of screens via which respective instructions for a plurality of print settings are received from a user, the screen generator being constructed within the information processing apparatus;
causing a display controller to display setting items corresponding to the screens in a predetermined order, and control switching between the screens based on the respective instructions corresponding to the setting items received from the user, the display controller being constructed within the information processing apparatus; and
causing a print setting limiter to limit the respective print settings, for which the respective instructions are received from the user via the respective screens, based on the predetermined order of the setting items, the print setting limiter being constructed within the information processing apparatus.

9. The print control method as claimed in claim 8, wherein
the setting items handled by the display controller include a layout setting, a sheet setting, a finishing setting, a detailed page setting, and a color adjustment setting, and wherein
the predetermined order indicates an order of the layout setting, the sheet setting, the finishing setting, the detailed page setting, and the color adjustment setting.

10. The print control method as claimed in claim 8, wherein
when there is an exclusive relationship between a higher-order print setting for which an instruction is received based on the screen corresponding to the setting item displayed at a higher-order position in the predetermined order and a lower-order print setting for which an instruction is received based on the screen corresponding to the setting item displayed at a lower-order position in the predetermined order, the print setting limiter limits the lower-order print setting.

11. The print control method as claimed in claim 8, further comprising:
causing a positional information storage part to store positional information indicating one of the screens via which the instructions for the plurality of the print settings are received, the positional information storage part being constructed within the information processing apparatus; and
causing a limit information generator to generate limit information for limiting the plurality of the print settings based on the positional information and the predetermined order of the setting items, the limit information generator being constructed within the information processing apparatus, wherein
the print setting limiter limits the plurality of the print settings for which the instructions are received from the user based on the limit information generated by the limit information generator.

12. The print control method as claimed in claim 8, wherein
the information processing apparatus is connected via the network to a controller externally attached to the printer and configured to perform image processing at high rates, wherein
the print control program is executed to construct a printer driver function to perform the plurality of the print settings by utilizing a user interface connected to a display part and an operations part, and wherein
the screen generator initially displays an output selection screen associated with a print output to which the user is able to optionally set a value by specifying operations via the operations part, and displays on the display part categories of the user interface in a print process order.

13. The print control method as claimed in claim 12, wherein
the screen generator provides the display part with a screen for a user to check, at a desired time, a condition under which functions of a lower-order category of the user interface are limited.

14. The print control method as claimed in claim 12, wherein
the print setting limiter limits functions of a same category of the user interface by placing higher priorities on higher-order print settings for which respective instructions are received based on the screens corresponding to the setting items displayed at higher-order positions in the predetermined order, and placing lower priorities on lower-order print settings for which respective instructions are received based on the screens corresponding to the setting items displayed at lower-order positions in the predetermined order.

15. An information processing apparatus connected to a printer via a network, the information processing apparatus comprising:
a screen generator configured to generate a plurality of screens via which respective instructions for a plurality of print settings are received from a user;
a display controller configured to display setting items corresponding to the screens in a predetermined order, and control switching between the screens based on the respective instructions corresponding to the setting items received from the user; and
a print setting limiter configured to limit the respective print settings for which the instructions are received from the user via the respective screens based on the predetermined order of the setting items.
